(19) United States
(12) Patent Application Publication
(10) Pub. No.: US 2026/0213223 A1
(43) Pub. Date: Jul. 23, 2026

(54) SIO2 SUPPORTED CEO2 AS RADICAL SCAVENGER

(71) Applicant: SYENSQO SPECIALTY POLYMERS ITALY S.p.A., Bollate (Milano) (IT)

(72) Inventors: Ludivine Malassis, Paris (FR); Lama Itani, Courbevoie (FR); Morgane Pellerin, Creil (FR); Claudio Oldani, Parabiago (MI) (IT); Libero Damen, Arese (MI) (IT)

(73) Assignee: SYENSQO SPECIALTY POLYMERS ITALY S.p.A., Bollate (Milano) (IT)

(21) Appl. No.: 19/142,137

(22) PCT Filed: Dec. 15, 2023
(86) PCT No.: PCT/EP2023/086213

§ 371 Date: Jun. 20, 2025

(30) Foreign Application Priority Data
Dec. 19, 2022 (EP) 22306930.3

(51) Int. Cl. H01M 4/86; C25B 9/23; C25B 11/04; H01M 8/10; H01M 8/1004

(52) U.S. Cl. CPC H01M 4/8668; C25B 9/23; C25B 11/04; H01M 8/1004; H01M 2008/1095

(57) ABSTRACT

Cerium oxide (CeO₂) coated silica (SiO₂) particles that optionally include inorganic groups —SO₂X and processes to prepare such particles are provided. The addition of the cerium oxide coated silica particles to fluorinated polymers containing sulfonic acid functional groups increases their stability towards radical degradation when used in fuel cell applications or in electrolysis applications.

### REFERENCE TO RELATED APPLICATIONS

This application claims priority from European patent application EP22306930.3 filed on Dec. 19, 2022, the whole content of this application being incorporated herein by reference for all purposes.

### TECHNICAL FIELD

The invention relates to cerium oxide (CeO₂) coated silica (SiO₂) particles capable of improving the resistance of ion exchange fluorinated polymeric membranes used in fuel cell application towards radical degradation. The invention further relates to compositions comprising the cerium oxide coated silica particles and ion exchange fluorinated polymers and to the ion exchange membranes obtained therefrom. The invention finally relates to a process for preparing SiO₂ supported CeO₂.

### BACKGROUND ART

Fluorinated polymers containing sulfonic acid ion exchange groups, due to their ion conducting properties, have found widespread use in the manufacture of electrolyte membranes for electrochemical devices such as electrolysis cells and fuel cells. Notable examples are for instance proton exchange membrane (PEM) fuel cells which employ hydrogen as the fuel and oxygen or air as the oxidant.

In a typical PEM fuel cell, hydrogen is introduced into the anode portion, where hydrogen reacts and separates into protons and electrons. The membrane transports the protons to the cathode portion, while allowing a current of electrons to flow through an external circuit to the cathode portion to provide power. Oxygen is introduced into the cathode portion and reacts with the protons and electrons to form water and heat.

The membrane requires excellent ion conductivity, gas barrier properties (to avoid the direct mixing of hydrogen and oxygen), mechanical strength and chemical, electrochemical and thermal stability at the operating conditions of the cell. In particular, long-term stability of the membrane is a critical requirement: the lifetime goal for stationary fuel cell applications being up to 40,000 hours of operations, 20,000 hours of operation being the requirement for automotive fuel cell applications.

Similar properties are required for proton exchange membranes for use in water electrolysis applications. Indeed, in electrolysis cells, water is introduced and oxidized to 02 and H⁺ at anode, H⁺ being further reduced at cathode to H₂, which is then collected.

Attack of the proton exchange membrane by hydrogen peroxide radicals (⁻OH, ⁻OOH), which are generated during fuel cell or electrolysis cell operation, has often been described as one of the causes of membrane degradation. Radical degradation of the membrane contributes to the reduction of the life of service of the fuel cell or the electrolysis cell. It is generally believed that, among other mechanisms, hydrogen peroxide is formed as a result of the reaction between hydrogen and oxygen that permeate through the membrane. Hydrogen peroxide then decomposes to form peroxy and hydroperoxy radicals, see for instance SCHLICK, S., et al. Degradation of fuel cell membranes using ESR methods: ex situ and in situ experiments. Polymer Preprints. 2009, vol. 50, no. 2, p. 745-746. Direct formation of the radicals is also believed to be possible.

Several attempts have been made to reduce radical degradation of fluorinated proton exchange membranes, for instance by incorporation into the membrane of suitable metallic salts or oxides. The use of salts of various metals, including rare earth metals, Al and Mn to increase the stability of ion exchange membranes for use in fuel cells is disclosed among others in EP 1702378 A (BDF IP HOLDINGS LTD) 20/09/2006 and EP 1662595 A (TOYOTA CHUO KENKYUSHO) 31/05/2006.

US 20070213209 A (E.I. DU PONT DE NEMOURS) 13/09/2007 discloses compounds for decomposing hydrogen peroxide in a fuel cell membrane electrode assembly which comprise a metal oxide from the group of alumina, silica, titanium oxides, zirconium oxide, manganese dioxide, Y₂O₃, Fe₂O₃, FeO, tin oxide, copper oxide, nickel oxide, tungsten oxide, germanium oxide, cerium oxides; a stabilizer selected from the group of metal ions and metalloid ions (e.g. boron); and at least one catalyst different from the stabilizer and selected from the group of cerium and ruthenium. The compounds disclosed in US20070213209 are prepared by adsorption of the catalyst on the metal oxide previously modified by the stabiliser. The catalyst particles are thus not incorporated into the crystal lattice of the metal oxide and may thus leach into the membrane and subsequently out of the membrane during the fuel cell operation.

ZHAO, D., et al. MnO₂/SiO₂—SO₃H nanocomposite as hydrogen peroxide scavenger for durability improvement in proton exchange membranes. J. Membrane Science. 2010, vol. 346, p.143-151 discloses nanosized mixed MnO₂/SiO₂ oxides having organic sulfonic acid groups grafted on their surface. The compounds are prepared by precipitating SiO₂ on the surface of nanosized MnO₂ followed by reacting the surface hydroxyl groups of SiO₂ with suitable organic sulfonating reagents, such as cyclic sultonic acid esters. In the mixed MnO₂/SiO₂ oxide disclosed in Zhao et al. MnO₂ is only physically combined with SiO₂, this may lead to the reduction of Mn(IV) to Mn(II) during the fuel cell operation and, given the higher solubility of Mn(II) species, to their subsequent removal.

GILL, C. S., et al. Sulfonic acid-functionalized silica-coated magnetic nanoparticle catalysts. J. Catalysis. 2007, vol. 251, p.145-152 discloses hybrid organic/inorganic catalysts comprising organic sulfonic acids grafted onto silica-coated magnetic nanoparticle supports.

In both of the systems described above organic hydrogenated moieties anchor the —SO₃H groups to the SiO₂ surface. The presence of these hydrogenated organic moieties in the inorganic oxide is believed to render the system poorly suitable for use in a fuel cell as it may provide an additional source of radical generation or radical degradation in the membrane under the fuel cell highly oxidising operating conditions.

WO 2014/009334 (Solvay Specialty Polymers Italy S.p.A.) discloses that the addition of certain mixed oxides of Si and at least one metal M to fluorinated polymers containing sulfonic acid functional groups increases the stability of proton exchange membranes prepared therefrom towards radical degradation. However, the mixed oxide generally comprises a weight ratio Si/M ranging from 1 to 40 i.e. corresponding to a high to very high amount of SiO₂, therefore containing few Ce species responsible for radical degradation protection. Moreover, the process disclosed therein comprises a hot acidic washing step which adds security concerns as well as cost increase.

U.S. Pat. No. 4,360,388 (Degussa Aktiengesellschaft) discloses cerium containing precipitated silica and compositions hardenable to elastomers based on diorganopolysiloxanes which contain the cerium containing precipitated silica. Cerium containing precipitated silica is also disclosed as fire retardant agent. The cerium containing precipitated silica have specific surface area measured by BET according to DIN 66 131 of at most 140±40 m²/g; nothing is said about the size of ceria crystallites. The process disclosed in U.S. Pat. No. 4,360,388 involves an aqueous cerium (IV) solution such as Ce(SO₄)₂, 4H₂O aqueous solution.

JP10230162 (Daikin Industries Ltd) discloses silica supported ceria catalyst wherein the size of ceria crystallites is not more than 4 nm as measured by half width XRD and the overall specific surface area is higher than 200 m²/g as measured by BET using nitrogen adsorption. Nothing is said about using such material to enhance the stability of proton exchange membranes towards radical degradation. The process disclosed in JP10230162 is performed at a pH value not exceeding 6.5 and involves the use of sodium hydroxide, sodium carbonate or potassium hydroxide. The use of such bases might be responsible for the presence of sodium or potassium salts in the final product.

### SUMMARY OF INVENTION

It has now been found that the addition of cerium oxide (CeO₂) coated silica (SiO₂) particles comprising from 10 wt % to 70 wt % of Ce element with regard to the total particles weight, presenting a specific surface area measured by BET ranging from 80 m²/g to 220 m²/g, and comprising CeO₂ crystallites having a size measured by XRD ranging from 5.0 nm to 10.0 nm, to fluorinated polymers containing sulfonic acid functional groups increases the stability of proton exchange membranes prepared therefrom towards radical degradation without the limitations of the prior art. The increase in stability is reflected in the longer life of service of the membrane when used in a fuel cell.

With regard to prior art, it has been found that a higher content of Ce in the cerium oxide (CeO₂) coated silica (SiO₂) particles according to the invention, combined with a higher specific surface area and a well-defined cerium oxide crystallite size, provides improved stability towards radical degradation to proton exchange membranes prepared from fluorinated polymers containing sulfonic acid functional groups.

A first object of the present invention is thus cerium oxide (Ce02) coated silica (SiO₂) particles comprising from 10 wt % to 70 wt % of Ce element with regard to the total particles weight, presenting a specific surface area measured by BET method ranging from 80 m²/g to 220 m²/g, comprising CeO₂ crystallites having a size measured by XRD ranging from 5.0 nm to 10.0 nm. The (CeO₂) coated silica (SiO₂) particles may optionally comprise inorganic —SO₂OZ functional groups, wherein Z is selected from the group consisting of H, alkaline metals and NH₄.

A second object of the invention is a liquid composition (LC1) comprising the cerium oxide coated silica particles of the first object dispersed in a liquid medium (L1).

A third object of the present invention is a process A for the preparation of the cerium oxide coated silica particles of the first object which comprises the following steps of:
a) providing an aqueous suspension (S1) comprising SiO₂, setting the pH value of said suspension between 7 and 11 by adding an ammonia (NH₃) aqueous solution;
b) adding under stirring to said suspension (S1) a Ce(NO₃)₃ water solution, while maintaining the pH value between 7 and 11 by adding an ammonia aqueous solution, to obtain a slurry comprising cerium hydroxide precipitated onto SiO₂;
c) filtrating of the slurry obtained in step b) to recover the cerium hydroxide precipitated onto SiO₂ in solid form;
d) conducting the calcination of the resulting solid obtained in step c), under oxidative atmosphere, at a temperature ranging from 250 to 800° C. for a duration ranging from 1 to 10 h obtaining the cerium oxide (CeO₂) coated silica (SiO₂) in the form of particles;
e) optionally milling the recovered particles of step d) to obtain the desired particles size.

A fourth object of the present invention is a process A′ for the preparation of the cerium oxide coated silica particles of the first object which comprises the following steps of:
a′) providing an ammonia aqueous solution (E) with a pH value set between 7 and 11;
b′) adding under stirring to said aqueous solution (E) an aqueous suspension (S2) comprising SiO₂ suspended in a Ce(NO₃)₃ water solution, while maintaining the pH value between 7 and 11 by adding an ammonia aqueous solution (E′), to obtain a slurry comprising cerium hydroxide precipitated onto SiO₂;
c′) filtrating of the slurry obtained in step b′) to recover the cerium hydroxide precipitated onto SiO₂ in solid form;
d′) conducting the calcination of the resulting solid obtained in step c′), under oxidative atmosphere, at a temperature ranging from 250 to 800° C. for a duration ranging from 1 to 10 h obtaining the cerium oxide (Ce02) coated silica (SiO₂) in the form of particles;
e′) optionally milling the recovered particles of step d′) to obtain the desired particles size.

A fifth object of the present invention is a process B for the preparation of the cerium oxide (Ce02) coated silica (SiO₂) particles of the first object which comprises the following steps of:
a″) providing an aqueous suspension (S3) comprising SiO₂, ammonia (NH₃) and optionally at least one source of inorganic groups —SO₂OZ;
b″) adding under stirring to said suspension (S3) a Ce(NO₃)₃ water solution, in such an amount that the molar ratio of NH₃ provided in step a″) and Ce element ranges from 2 to 4, to obtain a slurry comprising cerium hydroxide precipitated onto SiO₂;
c″) filtrating the slurry to recover the cerium hydroxide Ce(OH)₃ precipitated onto SiO₂ in solid form;
d″) conducting the calcination of the resulting solid under oxidative atmosphere at a temperature ranging from 250 to 800° C. for a duration ranging from 1 to 10 h obtaining the cerium oxide (CeO₂) coated silica (SiO₂) in the form of particles;
e″) optionally milling the recovered particles of step d″) to obtain the desired particles size.

An advantage of setting or regulating the pH value with ammonia as described in process A, process A′ and process B of the present invention rather than with NaOH or KOH, is that no remaining salts are present in the final product. Indeed, the presence of sodium or potassium salts may impair the efficiency and the stability of the polymer membrane when the cerium oxide coated silica particles according to the invention are used in fuel cell application.

Indeed, without being bound by any theory, if some ammonia remains in the product before calcination after respectfully step c), c′) or c″), it is easily removed from the desired product, during calcination performed in respectfully step d), d′) or d″).

Therefore, an advantage of regulating the pH value with ammonia is that no salts have to be washed out before recovering the final product thus simplifying the process.

Similarly, an advantage of using Ce(NO₃)₃ as raw material is that if some remains in the product before calcination after respectfully step c), (c′) or c″), it is transformed during calcination performed in respectfully step d), d′) or d″) in nitrogen oxides (NOₓ) which are gases and thus easily removed from the desired product and in CeO₂.

A sixth object of the invention is a composition (C) comprising at least one fluorinated polymer comprising —SO₂X functional groups, wherein X is selected from X′ or from OZ and wherein X′ is selected from the group consisting of F, Cl, Br, I and Z is selected from the group consisting of H, alkaline metals, NH₄, and particles of the first object.

Another object of the invention is a liquid composition (LC) comprising the composition (C).

Still another object is a process to prepare composition (C) or (LC).

A further object of the present invention is an article, in particular a membrane or an electrocatalyst layer, comprising at least one fluorinated polymer comprising —SO₂X functional groups and cerium oxide (CeO₂) coated silica (SiO₂) particles as defined above.

Finally, another object is a fuel cell or an electrolysis cell comprising the article according to the invention.

### DISCLOSURE OF INVENTION

A first object of the present invention is cerium oxide (CeO₂) coated silica (SiO₂) particles comprising from 10 wt % to 70 wt % of Ce element with regard to the total particles weight, presenting a specific surface area, measured by the BET, ranging from 80 m²/g to 220 m²/g, comprising CeO₂ crystallites having a size measured by XRD ranging from 5.0 nm to 10.0 nm.

The cerium oxide (CeO₂) coated silica (SiO₂) particles optionally comprise inorganic —SO₂OZ functional groups, wherein Z is selected from the group consisting of H, alkaline metals and NH₄. The term “inorganic groups —SO₂OZ” is used herein with reference to the cerium oxide (CeO₂) coated silica (SiO₂) particles to indicate that the groups —SO₂OZ present in the cerium oxide coated silica particles are not bound to organic moieties, wherein the expression “organic moiety” indicates any moiety containing at least one carbon atom. All the groups —SO₂OZ in the cerium oxide coated silica particles are inorganic groups —SO₂OZ.

Without being bound by theory it is believed that the groups —SO₂OZ are bound via the sulphur atom to the cerium oxide coated silica particles surface. The groups —SO₂OZ are bound via the sulphur atom to at least one Si, Ce or oxygen atom. Typically the groups —SO₂OZ are bound via the sulphur atom to at least a portion of the metal Ce.

The cerium oxide (CeO₂) coated silica (SiO₂) particles according to the present invention comprise from 10 wt % to 70 wt % of Ce element with regard to the total particles weight. In some embodiments, the cerium oxide coated silica particles comprise from 40 wt % to 70 wt %, even from 40 wt % to 65 wt %, of Ce element. In some other embodiments, the cerium oxide coated silica particles comprise 50 wt % of Ce element. Still in some other embodiments, the cerium oxide coated silica particles comprise from 10 wt % to 45 wt %, even from 10 wt % to 40 wt % of Ce element.

A theoretical Ce content is set before the preparation of the particles by using the appropriate amount of raw materials. This content can be confirmed after synthesis by using ICP-OES analysis performed on the cerium oxide coated silica particles according to the present invention. Inductively coupled plasma optical emission spectroscopy (ICP-OES) was performed on mineralized samples prepared by method well known by the person skilled in the art.

When present, the amount of inorganic groups —SO₂OZ in the cerium oxide coated silica particles is generally at least 0.2% of the total amount of atoms of Ce, typically at least 0.5%. The amount of inorganic groups —SO₂OZ in the cerium oxide coated silica particles may be up to 50% with respect to the total amount of atoms of Ce. The inorganic groups —SO₂OZ may be bound to the Ce, Si or oxygen atoms in the cerium oxide (CeO₂) coated silica (SiO₂) particles.

The amount of inorganic groups —SO₂OZ in the cerium oxide coated silica particles can be determined through ICP-OES measurement of S content as generally known to those skilled in the art.

Preferably, the cerium oxide coated silica particles does not contain any organic moiety i.e. any moiety containing at least one carbon atom as above defined.

The cerium oxide coated silica particles according to the invention exhibit a specific surface area measured by BET ranging from 80 m²/g to 220 m²/g; typically ranging from 100 m²/g to 220 m²/g; sometimes ranging from 130 m²/g to 220 m²/g. In some instances, the specific surface area, measured by BET, may be no more than 215 m²/g, even no more than 210 m²/g or even no more than 200 m²/g.

The cerium oxide coated silica particles according to the invention have a particle size distribution such that D₅₀<0.20 μm, preferably D₅₀<0.18 μm the distribution being obtained by laser diffraction from a dispersion of the particles in 1-propanol.

D₅₀ has the usual meaning used in the field of particle size distributions. For the sake of clarity Dn corresponds to the diameter of the particles for which n % of the particles on a volume basis have a diameter which is less than Dn. D₅₀ (median) is accordingly defined as the size value corresponding to the cumulative distribution at 50%, the distribution being a volume distribution.

Besides, the particles according to the invention generally have D₅₀<0.50 μm, preferably D₅₀<0.45 μm, more preferably D₅₀<0.42 μm, the distribution being obtained by laser diffraction from a dispersion of the particles in 1-propanol.

In some embodiments, the cerium oxide coated silica particles according to the invention have D₅₀<0.20 μm and D₅₀<0.50 μm, both on a volume basis.

The cerium oxide coated silica particles according to the invention comprise CeO₂ crystallites having a size measured by XRD ranging from 5.0 nm to 10.0 nm; from 5.0 nm to 9.0 nm; from 5.0 nm to 8.0 nm; in some instances ranging from 5.0 nm to 7.8 nm.

Generally, the cerium oxide crystallites are formed onto the silica particles and thus bonded to said silica particles.

It is believed that CeO₂ crystallites having lower size may give rise to problems of leaching of Ce ions from the particles when in use in proton exchange membranes in electrochemical devices.

A second object of the present invention is a liquid composition (LC1) comprising the cerium oxide coated silica particles according to the invention, dispersed in a liquid medium (L1).

The cerium oxide coated silica particles comprised in (LC1) generally are characterized by a D₅₀<0.20 μm, preferably D₅₀<0.18 μm.

Besides, the particles comprised in (LC1) generally are characterized by a D₅₀<0.50 μm, preferably D₅₀<0.45 μm, more preferably D₅₀<0.42 μm.

In some embodiments, the cerium oxide coated silica particles comprised in (LC1) are characterized by a particle size distribution such that D₅₀<0.20 μm and D₅₀<0.50 μm.

In some embodiments, the liquid medium comprises water, alcohols or water/alcoholic mixture (L1).

Suitable alcohols, which can be used, in particular as water/alcoholic mixture, are notably methanol, ethanol, propyl alcohols (i.e. 1-propanol, 2-propanol), ethylene glycol, diethylene glycol.

In some other embodiments, the liquid medium (L1) further comprises polar aprotic organic solvents such as ketones, like acetone, methylethylketone, esters, like methylacetate, dimethylcarbonate, diethylcarbonate, ethylacetate, nitriles, like acetonitrile, sulphoxides, like dimethylsulfoxide (DMSO), sulfones like dimethylsulfone (DMSO2), amides, like N,N-dimethylformamide, N,N-dimethylacetamide, pyrrolidones, like N-methylpyrrolidone, N-ethylpyrrolidone and mixtures thereof.

In some embodiments, the liquid medium (L1) is water, alcohol, or a mixture of water and alcohol, preferably of water and propyl alcohol(s).

Good results were obtained with liquid composition (LC1) comprising the particles according to the invention dispersed in 1-propanol, 2-propanol and mixtures thereof.

Generally, the liquid composition (LC1) according to the invention is prepared by suspending the particles according to the invention in the liquid medium (L1) by stirring at room temperature.

In some embodiments, the liquid composition (LC1) is prepared by sonicating the particles according to the invention in the liquid medium (1) for 0.5 to 6 h to obtain complete dispersion of the particles.

In some other embodiments, the liquid composition (LC1) is prepared by suspending the particles according to the invention in the liquid medium (L1) by stirring at room temperature and by further sonicating to obtain complete dispersion of the solid.

Still, in some other embodiments, the liquid composition (LC1) is prepared by wet milling the cerium oxide coated silica particles according to the invention in the liquid medium (L1) to reach the desired particles size distribution before suspending the particles in additional amount of (L1) as above described to reach the desired content of cerium oxide coated silica particles in wt % based on the total weight of said liquid composition (LC1).

The liquid composition (LC1) according to the invention generally comprises at least 0.1 wt %, preferably at least 0.5 wt % and more preferably at least 1.0 wt % of cerium oxide coated silica particles based on the total weight of said liquid composition (LC1).

The liquid composition (LC1) according to the invention comprises generally at most 25.0 wt %, preferably at most 20.0 wt % and more preferably at most 15.0 wt % of cerium oxide coated silica particles based on the total weight of said liquid composition (LC1).

Generally, the liquid composition (LC1) according to the invention comprises from 0.1 to 25.0 wt %, preferably from 1.0 to 15.0 wt % of cerium oxide coated silica particles based on the total weight of said liquid composition (LC1).

In some embodiments, the liquid composition (LC1) according to the invention comprises additional ingredients and/or additives such as amines or carboxylic acids.

The inventive cerium oxide (Ce02) coated silica (SiO₂) particles according to the invention can be prepared by a process A which comprises the following steps of:
a) providing an aqueous suspension (S1) comprising SiO₂, setting the pH value of said suspension between 7 and 11 by adding an ammonia (NH₃) aqueous solution;
b) adding under stirring to said suspension (S1) a Ce(NO₃)₃ water solution, while maintaining pH between 7 and 11 by adding an ammonia aqueous solution, to obtain a slurry comprising cerium hydroxide precipitated onto SiO₂;
c) filtering of the slurry obtained in step b) to recover the cerium hydroxide precipitated onto SiO₂ in solid form;
d) conducting the calcination of the resulting solid obtained in step c), under oxidative atmosphere, at a temperature ranging from 250 to 800° C. for a duration ranging from 1 to 10 h obtaining the cerium oxide (CeO₂) coated silica (SiO₂) in the form of particles;
e) optionally milling the recovered particles of step d) to obtain the desired particles size.

Generally process A is conducted when the targeted cerium oxide coated silica particles comprise from 10 wt % to 70 wt % of Ce element.

In some preferred embodiments process A is conducted when the targeted cerium oxide coated silica particles comprise more than 40 wt % and up to 70 wt % of Ce element.

In step a) of the process, the aqueous suspension (S1) generally comprises from 5 wt % to 10 wt % of SiO₂ with regards to the total weight of said the aqueous suspension (S1). The aqueous suspension (S1) preferably comprises from 5 wt % to 8 wt %, more preferably from 6 wt % to 7 wt % of SiO₂ with regards to the total weight of the aqueous suspension (S1). Good results were obtained with a suspension (S1) at 6.5 wt % of SiO₂.

The ammonia (NH₃) aqueous solution used in steps a) and b) of the process generally comprises from 5 wt % to 11 wt % of ammonia. Preferably it comprises from 6 wt % to 10 wt %, more preferably from 7 wt % to 9 wt % of ammonia. Good results were obtained with an aqueous solution at 8 wt % of ammonia.

Generally in steps a) and b) the pH value is set and maintained between 7 and 11 through adding an ammonia aqueous solution. Good results were obtained while setting and maintaining the pH value at 8.5.

In some embodiments in step a) the pH is set at a value between 7 and 11 which is different from the pH value between 7 and 11 maintained in step b).

In step b) the concentration of the Ce(NO₃)₃ water solution added to the suspension (S1) generally ranges from 1.00 to 5.00 mol/L, preferably from 1.50 to 4.00 mol/L. Good results were obtained with a concentration of 2.87 mol/L.

Ce(NO₃)₃ solution is generally added to the suspension (S1) while stirring for a period of time ranging from 10 minutes to 3 hours; preferably ranging from 30 minutes to 2 hours. Good results were obtained for a period of time of one hour.

In step c) filtration can be performed using e.g. a Buchner funnel at lab scale. At larger scale, any system of filtration well known in the art for dewatering such as filter presses can be used.

In step d) calcination can be performed in any oven under oxidative atmosphere. For example, calcination can be conducted in a rotary drum kiln. In some embodiments, air is the oxidative atmosphere.

Generally, the calcination is conducted at a temperature ranging from 250° C. to 800° C., preferably ranging from 400° C. to 800° C. Good results were obtained with a calcination conducted at 500° C.

In some embodiments the calcination is performed at 800° C.

Generally, the calcination is conducted for a duration ranging from 1 to 10 h, preferably ranging from 2 to 8 h. Good results were obtained with a calcination conducted during 3 h at a temperature of 500° C. In some embodiments the calcination is performed during 3 h at 800° C.

In step e) milling can be performed by treating the particles obtained in step d) in any apparatus well known by the skilled person such as a hammer mill, planetary ball mill, a blade mill or a jet mill.

In some embodiments, milling can be performed in the presence of at least one solvent i.e. via so called wet milling using suitable well known equipment. Suitable solvents for wet milling are 1-propanol, 2-propanol, ethanol, water and mixtures thereof. Good results were obtained using 1-propanol or 2-propanol.

In some other embodiments, a dry milling is performed beforehand followed by a wet milling typically using 1-propanol.

Generally in step e) cerium oxide (Ce02) coated silica (SiO₂) particles are deagglomerated by dry milling.

In order to obtain cerium oxide coated silica particles presenting D₅₀<0.20 μm and D₅₀<0.50 μm wet milling is generally used in step e).

In some embodiments, in order to obtain cerium oxide coated silica particles presenting D₅₀<0.20 μm and D₅₀<0.50 μm in step e) dry milling is performed before wet milling.

In other embodiments, the inventive cerium oxide (Ce02) coated silica (SiO₂) particles according to the invention can be prepared by a process A′ which comprises the following steps of:
a′) providing an ammonia aqueous solution (E) with a pH value set between 7 and 11;
b′) adding under stirring to said solution (E) an aqueous suspension (S2) comprising SiO₂ suspended in a Ce(NO₃)₃ water solution, while maintaining the pH value between 7 and 11 by adding an ammonia aqueous solution (E′), to obtain a slurry comprising cerium hydroxide precipitated onto SiO₂;
c′) filtering of the slurry obtained in step b′) to recover the cerium hydroxide precipitated onto SiO₂ in solid form;
d′) conducting the calcination of the resulting solid obtained in step c′), under oxidative atmosphere, at a temperature ranging from 250 to 800° C. for a duration ranging from 1 to 10 h obtaining the cerium oxide (Ce02) coated silica (SiO₂) in the form of particles;
e′) optionally milling the recovered particles of step d′) to obtain the desired particles size.

Generally process A′ is conducted when the targeted cerium oxide coated silica particles comprise from 10 wt % to 70 wt % of Ce element.

In some preferred embodiments process A′ is conducted when the targeted cerium oxide coated silica particles comprise more than 40 wt % and up to 70 wt % of Ce element.

The ammonia (NH₃) aqueous solution (E) used in steps a′) of the process A′ generally comprises from 5 wt % to 11 wt % of ammonia. Sometimes it comprises from 6 wt % to 10 wt %, often from 7 wt % to 9 wt % of ammonia.

The ammonia (NH₃) aqueous solution (E′) used in steps b′) of the process A′ generally comprises from 5 wt % to 11 wt % of ammonia. Sometimes it comprises from 6 wt % to 10 wt %, often from 7 wt % to 9 wt % of ammonia.

In some embodiments the ammonia (NH₃) aqueous solution (E) is different from (E′).

In some embodiments the ammonia (NH₃) aqueous solution (E) is the same as (E′).

Generally in steps a′) and b′) the pH value is set and maintained between 7 and 11 through adding an ammonia solution. Sometimes the pH value is set and maintained at 8.5.

In some embodiments in step a′) the pH is set at a value between 7 and 11 which is different from the pH value between 7 and 11 maintained in step b′).

In step b′) the concentration of Ce(NO₃)₃ water solution generally ranges from 1 to 5 mol/L, sometimes from 1.5 to 4 mol/L.

In step b′) of the process, the aqueous suspension (S2) generally comprises from 2.5 wt % to 15.0 wt % of SiO₂ with regards to the total weight of the aqueous suspension (S2).

In step b′) the aqueous suspension (S2) generally comprises from 2.5 wt % to 15.0 wt % of SiO₂ with regards to the total weight of the aqueous suspension (S2) dispersed in a from 1 to 5 mol/L Ce(NO₃)₃ water solution.

Suspension (S2) is generally added to the solution (E) while stirring for a period of time ranging from 10 minutes to 3 hours; sometimes ranging from 30 minutes to 2 hours; often for a period of time of one hour.

Steps c′), d′) and e′) are generally performed as previously described respectfully for steps c), d) and e).

Still in other embodiments, the inventive cerium oxide (Ce02) coated silica (SiO₂) particles according to the invention are prepared by a process B which comprises the following steps of:
a″) providing an aqueous suspension (S3) comprising SiO₂, ammonia (NH₃) and optionally at least one source of inorganic groups —SO₂OZ;
b″) adding under stirring to said suspension (S3) a Ce(NO₃)₃ solution, in such an amount that the molar ratio of NH₃ provided in step a″) and Ce element ranges from 2 to 4, to obtain a slurry comprising cerium hydroxide precipitated onto SiO₂;
c″) filtering the slurry to recover the cerium hydroxide Ce(OH)₃ precipitated onto SiO₂ in solid form;
d″) conducting the calcination of the resulting solid under oxidative atmosphere at a temperature ranging from 250 to 800° C. for a duration ranging from 1 to 10 h obtaining the cerium oxide coated silica in the form of particles;
e″) optionally milling the recovered particles of step d″) to obtain the desired particles size.

Generally process B is conducted when the targeted cerium oxide (CeO₂) coated silica (SiO₂) particles comprise from 10 wt % to 40 wt % of Ce element.

In step a″) of the process, the aqueous suspension (S3) generally comprises from 4 wt % to 10 wt % of SiO₂ with regards to the total weight of said aqueous suspension (S3). The aqueous suspension (S3) preferably comprises from 4.5 wt % to 8 wt %, more preferably from 5 wt % to 7 wt % of SiO₂ with regards to the total weight of the aqueous suspension (S3). Good results were obtained with a suspension at 6.5 wt % of SiO₂.

In step b″) the concentration of the Ce(NO₃)₃ solution added to the suspension (S3) generally ranges from 1 to 5 mol/L, preferably from 1.5 to 4 mol/L. Good results were obtained with a concentration of 2.87 mol/L.

In step b″) Ce(NO₃)₃ solution is generally added in such an amount that the molar ratio of NH₃ provided in step a″) and Ce element ranges from 2.0 to 4.0, typically from 2.5 to 3.5. Good results were obtained with adding Ce(NO₃)₃ solution in such an amount that the molar ratio of NH₃ provided in step a″) and Ce element equal 3.0.

Ce(NO₃)₃ solution is generally added to the suspension (S3) while stirring for a period of time ranging from 15 minutes to 3 hours; preferably ranging from 30 minutes to 2 hours. Good results were obtained when Ce(NO₃)₃ solution was added to the suspension (S3) for a period of time of one hour.

Steps c″), d″) and e″) are generally performed as previously described respectfully for steps c), d) and e).

In some embodiments step a″) of the process B consists in providing an aqueous suspension comprising SiO₂, ammonia (NH₃) and at least one source of inorganic groups —SO₂OZ.

Suitable sources of inorganic groups —SO₂OZ are for instance those selected from the group consisting of (NH₄)₂SO₃·H₂O, NH₄SO₃NH₂, HSO₃Cl, Na₂S₂O₅/NaHSO₃, (NH₄)HSO₃, H₂SO₄. Preferably the source of inorganic groups —SO₂X is (NH₄)₂SO₃—H₂O.

When present, the source of inorganic groups —SO₂OZ is typically from 2 to 10 wt %, preferably 5 to 7 wt % of the total amount of SiO₂ and Ce(NO₃)₃ added during the whole process B.

In some embodiments, the aqueous suspensions (S1), (S2) or (S3) of respective processes A, A′ or B may comprise polar solvents such as alcohols.

Generally, during processes A, A′ and B according to the invention, the cerium oxide crystallites are formed onto the silica particles and thus are bonded to said silica particles.

In some embodiments, the cerium oxide coated silica particles according to the invention are substantially free of free cerium oxide crystallites not linked to the silica particles.

In some other embodiments, the cerium oxide coated silica particles according to the invention are completely free of free cerium oxide crystallites not linked to the silica particles.

Any type of silica SiO₂ may be used for the preparation of cerium oxide (CeO₂) coated silica (SiO₂) particles according to the invention, such as colloidal silica, fumed silica, precipitated silica and the like. Preferably SiO₂ having a particle size of from 1.0 nm to 100.0 nm, preferably from 5.0 to 50.0 nm is preferred.

Notable non-limiting examples of suitable commercially available precipitated silicas are for instance: Tixosil® 73, Tixosil® 63, Tixosil® SoftClean, Tixosil® 43, Tixosil® 331 all available from Solvay SA.

Colloidal silica Ludox® available from W.R. Grace & Co. can also be used.

Ce(NO₃)₃·6H₂O is generally used to prepare the aqueous solution of Ce(NO₃)₃.

A further object of the invention is a composition (C) comprising at least one polymer comprising —SO₂X functional groups, wherein X is selected from X′ or from OZ and wherein X′ is selected from the group consisting of F, Cl, Br, I and Z is selected from the group consisting of H, alkaline metals, NH₄, and cerium oxide (CeO₂) coated silica (SiO₂) particles as detailed above.

Composition (C) may comprise at least one fluorinated polymer comprising —SO₂X functional groups, wherein X is selected from X′ or from OZ and wherein X′ is selected from the group consisting of F, Cl, Br, I and Z is selected from the group consisting of H, alkaline metals, NH₄, and cerium oxide (CeO₂) coated silica (SiO₂) particles as detailed above.

The expression “fluorinated″ is used herein to refer to compounds (e.g. compounds, polymers, monomers etc.) that are either totally or partially fluorinated, i.e. wherein all or only a part of the hydrogen atoms have been replaced by fluorine atoms. Preferably, the term “fluorinated″ refers to compounds that contain a higher proportion of fluorine atoms than hydrogen atoms, more preferably the term refers to compounds that are totally free of hydrogen atoms, i.e. wherein all the hydrogen atoms have been replaced by fluorine atoms.

Within the context of the present invention the expression “at least one″ when referred to a “fluorinated polymer” is intended to denote one or more than one polymer. Mixtures of polymers can be advantageously used for the purposes of the invention.

The composition (C) may comprise the at least one fluorinated polymer in the neutral form, wherein the expression “neutral form” indicates that in the —SO₂X functional groups X is X′ and X is selected from the group consisting of F, Cl, Br, I. Preferably X′ is selected from F or Cl. More preferably X′ is F.

Alternatively, the composition (C) may comprise the at least one fluorinated polymer in the ionic (acid or salified) form, wherein the expression “ionic form” indicates that in the —SO₂X functional groups X is OZ and Z is selected from the group consisting of H, alkaline metals, NH₄.

For the avoidance of doubt, the term “alkaline metal” is hereby intended to denote the following metals: Li, Na, K, Rb, Cs. Preferably the alkaline metal is selected from Li, Na, K.

Fluorinated polymers comprising —SO₃Z functional groups (wherein X═OZ) are typically prepared from fluorinated polymers comprising —SO₂X′ functional groups, preferably —SO₂F functional groups, by methods known in the art.

The fluorinated polymer can be obtained in its salified form, i.e. wherein Z is a cation selected from the group consisting of NH₄ and alkaline metals, by treatment of the corresponding polymer comprising—SO₂X′ functional groups, typically —SO₂F functional groups, with a strong base (e.g. NaOH, KOH).

The fluorinated polymer can be obtained in its acid form, i.e. wherein Z is H, by treatment of the corresponding salified form of the polymer with a concentrated acid solution.

Suitable fluorinated polymers comprising —SO₂X′ functional groups are those polymers comprising recurring units deriving from at least one ethylenically unsaturated fluorinated monomer containing at least one —SO₂X′ functional group (monomer (A) as hereinafter defined) and recurring units deriving from at least one ethylenically unsaturated fluorinated monomer (monomer (B) as hereinafter defined).

The phrase “at least one monomer” is used herein with reference to monomers of both type (A) and (B) to indicate that one or more than one monomer of each type can be present in the polymer. Hereinafter the term monomer will be used to refer to both one and more than one monomer of a given type.

Non limiting examples of suitable monomers (A) are:
sulfonyl halide fluoroolefins of formula: CF₂═CF(CF₂)ₚSO₂X′ wherein p is an integer between 0 and 10, preferably between 1 and 6, more preferably p is equal to 2 or 3, and wherein preferably X′═F;
sulfonyl halide fluorovinylethers of formula: CF₂═CF—O—(CF₂)ₘSO₂X′ wherein m is an integer between 1 and 10, preferably between 1 and 6, more preferably between 2 and 4, even more preferably m equals 2, and wherein preferably X′═F;
sulfonyl halide fluoroallylethers of formula: CF₂═CFCF₂—O—(CF₂)_{q}SO₂X′ wherein q is an integer between 1 and 10, preferably between 1 and 6, more preferably between 2 and 4, even more preferably q equals 2, and wherein preferably X′═F;
sulfonyl halide fluoroalkoxyvinylethers of formula: CF₂═CF—(OCF₂CF(RF1))_{w}—O—CF₂(CF(RF2))_{y}SO₂X′ wherein w is an integer between 0 and 2, RF1 and RF2, equal or different from each other, are independently F, Cl or a C₁-C₁₀ fluoroalkyl group, optionally substituted with one or more ether oxygens, y is an integer between 0 and 6; preferably w is 1, RF1 is —CF₃, y is 1 and RF2 is F, and wherein preferably X′═F;
sulfonyl halide aromatic fluoroolefins of formula CF₂═CF—Ar—SO₂X′ wherein Ar is a C₅-C₁₅ aromatic or heteroaromatic substituent, and wherein preferably X′═F.

Preferably monomer (A) is selected from the group of the sulfonyl fluorides, i.e. wherein X′═F.

More preferably monomer (A) is selected from the group of the fluorovinylethers of formula CF₂═CF—O—(CF₂)m-SO₂F, wherein m is an integer between 1 and 6, preferably between 2 and 4.

Even more preferably monomer (A) is CF₂═CFOCF2CF₂—SO₂F (perfluoro-5-sulfonylfluoride-3-oxa-1-pentene).

Non limiting examples of suitable ethylenically unsaturated fluorinated monomers of type (B) are:
C₂-C₈ fluoroolefins, such as tetrafluoroethylene, pentafluoropropylene, hexafluoropropylene, and hexafluoroisobutylene;
vinylidene fluoride;
C₂-C₈ chloro- and/or bromo- and/or iodo-fluoroolefins, such as chlorotrifluoroethylene and bromotrifluoroethylene;
fluoroalkylvinylethers of formula CF₂═CFOR_{f1}, wherein R_{f1} is a C₁-C₆ fluoroalkyl, e.g. —CF₃, —C₂F₅, —C₃F₇;
fluoro-oxyalkylvinylethers of formula CF₂═CFOR_{O1}, wherein R_{O1} is a C₁-C₁₂ fluoro-oxyalkyl having one or more ether groups, for example perfluoro-2-propoxy-propyl;
fluoroalkyl-methoxy-vinylethers of formula CF₂═CFOCF2OR_{f2} in which R_{f2} is a C₁-C₆ fluoroalkyl, e.g. —CF₃, —C₂F₅, —C₃F₇ or a C₁-C₆ fluorooxyalkyl having one or more ether groups, like —C₂F₅—O—CF₃;
fluorodioxoles, of formula:

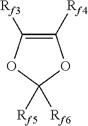

wherein each of R_{f3}, R_{f4}, R_{f5}, R_{f6}, equal or different each other, is independently a fluorine atom, a C₁-C₆ fluoroalkyl, optionally comprising one or more oxygen atom, e.g. —CF₃, —C₂F₅, —C₃F₇, —OCF₃, —OCF₂CF₂OCF₃.

Preferably monomer (B) is selected among:
C₃-C₈ fluoroolefins, preferably tetrafluoroethylene and/or hexafluoropropylene;
chloro- and/or bromo- and/or iodo-C₂-C₆ fluoroolefins, like chlorotrifluoroethylene and/or bromotrifluoroethylene;
fluoroalkylvinylethers of formula CF₂═CFOR_{f1} in which R_{f1} is a C₁-C₆ fluoroalkyl, e.g. —CF₃, —C₂F₅, —C₃F₇;
fluoro-oxyalkylvinylethers of formula CF₂═CFOR_{O1}, in which R_{O1} is a C₁-C₁₂ fluorooxyalkyl having one or more ether groups, like perfluoro-2-propoxy-propyl.

More preferably monomer (B) is tetrafluoroethylene.

The fluorinated polymer comprising —SO₂X′ functional groups may be prepared by any polymerization process known in the art. Suitable processes for the preparation of such polymers are for instance those described in EP 1323751 A (SOLVAY SOLEXIS SPA) 02/07/2003 and EP 1172382 A (SOLVAY SOLEXIS SPA) 16/11/2002.

Alternatively, the polymer comprising —SO₂X functional groups may be a non-fluorinated polymer. The polymer may be an aromatic polymer.

Typical examples of an aromatic polymer comprising —SO₂X functional groups suitable for composition (C) include a polymer in which sulfonic groups are introduced into a polymer having an aromatic ring in a main chain.

A polymer having an aromatic ring in a main chain may be, for example, such that the main chain is discontinued by a hetero atom such as an oxygen atom. Examples of such an aromatic polymer include polyether ketone, polyether ether ketone, polysulfone, polyether sulfone, polyether ether sulfone, poly(arylene ether), polyimide, polyphenylene, poly((4-phenoxybenzoyl)-1,4-phenylene), polyphenylene sulfide and, sulfoarylated polybenzimidazole, sulfoalkylated polybenzimidazole, phosphoalkylated polybenzimidazole, and phosphonated poly(phenylene ether).

The cerium oxide (CeO₂) coated silica (SiO₂) particles according to the invention are present in the composition (C) in any amount sufficient to reduce the degree of radical degradation of the polymer comprising —SO₂X functional groups.

The amount of Ce element with regards to the total weight of the polymer in the composition (C) comprising the cerium oxide (CeO₂) coated silica (SiO₂) particles according to the invention is generally of at least 0.1 wt %, preferably of at least 0.2 wt %, more preferably of at least 0.5 wt %.

The amount of Ce element with regards to the total weight of the polymer in the composition (C) comprising the cerium oxide (CeO₂) coated silica (SiO₂) particles according to the invention generally does not exceed 20.0 wt %, preferably it does not exceed 15.0 wt %, more preferably it does not exceed 10.0 wt %.

The polymer comprising —SO₂X functional groups in composition (C) is preferably a fluorinated polymer.

The composition (C) may be prepared using conventional methods.

When both the fluorinated polymer and the cerium oxide (CeO₂) coated silica (SiO₂) particles are provided in solid form, for instance in the form of powder, pellets or granules the composition (C) may be prepared using techniques such as dry blending, melt blending, or extrusion.

An object of the present invention is thus, a process for the preparation of a composition (C) comprising blending the cerium oxide (CeO₂) coated silica (SiO₂) of the invention and the at least one fluorinated polymer comprising —SO₂X functional groups in solid form.

Alternatively, another object of the present invention is a process for the preparation of a composition (C) comprising blending the cerium oxide (CeO₂) coated silica (SiO₂) of the invention and the at least one fluorinated polymer comprising —SO₂X functional groups in a liquid medium (L) to provide a liquid composition (LC).

These processes are advantageous for the preparation of compositions (C) wherein the fluorinated polymer comprises —SO₃Z functional groups, wherein Z is as defined above, and in particular —SO₃H functional groups.

A liquid composition (LC2) may be prepared by a dissolution process wherein fluorinated polymer is contacted with a liquid medium (L2) under suitable temperature conditions.

Generally, the liquid medium (L2) comprises water, alcohol or a water/alcoholic mixture, and optionally comprises additional ingredients and/or additives.

Suitable alcohols which can be used, in particular as water/alcoholic mixture, are notably methanol, ethanol, propyl alcohols (i.e. isopropanol, n-propanol), ethylene glycol, diethylene glycol.

Liquid medium (L2) may further comprise a solvent selected from polar aprotic organic solvents such as ketones, like acetone, methylethylketone, esters, like methylacetate, dimethylcarbonate, diethylcarbonate, ethylacetate, nitriles, like acetonitrile, sulphoxides, like dimethylsulfoxide (DMSO), sulfones like dimethylsulfone (DMSO2), amides, like N,N-dimethylformamide, N,N-dimethylacetamide, pyrrolidones, like N-methylpyrrolidone, N-ethylpyrrolidone and mixtures thereof.

In some embodiments the liquid medium (L2) comprises water or a mixture of water and alcohol, preferably of water and propyl alcohol(s).

Good results have been obtained with liquid medium (L2) being water or a mixture of water and alcohol, preferably of water and propyl alcohol(s).

Good results have been also obtained with liquid medium (L2) being a mixture of water, propyl alcohol(s) and DMSO2.

The liquid composition (LC2) may advantageously be prepared by contacting the fluorinated polymer with water or a mixture of water and alcohol, at room temperature or at a temperature of from 40° C. to 300° C. in an autoclave.

In some other embodiments, the liquid composition (LC2) may advantageously be prepared by contacting the fluorinated polymer with water, propyl alcohol(s) and DMSO2, at room temperature or at a temperature of from 40° C. to 300° C. in an autoclave.

The cerium oxide (Ce02) coated silica (SiO₂) particles may be added to the liquid composition (LC2) comprising the fluorinated polymer pure or as the previously described liquid composition (LC1) according to the invention to give a liquid composition (LC) comprising at least one fluorinated polymer comprising —SO₂X functional groups and cerium oxide (Ce02) coated silica (SiO₂) particles dispersed or dissolved in a liquid medium (L).

Accordingly, the liquid medium (L) is the liquid medium (L2) when the cerium oxide (Ce02) coated silica (SiO₂) particles are added pure and, the liquid medium (L) is the combination of the liquid medium (L2) and of the liquid medium (L1) when the cerium oxide (Ce02) coated silica (SiO₂) particles are added as the liquid composition (LC1).

A further object of the invention is a liquid composition (LC) comprising at least one fluorinated polymer comprising —SO₂X functional groups and cerium oxide (Ce02) coated silica (SiO₂) particles dispersed or dissolved in a liquid medium (L) as previously described. Typically the liquid medium (L) comprises water or a mixture of water and alcohol.

In some embodiments, the liquid medium (L) is water or a mixture of water and propanol(s), preferably 1-propanol.

In some other embodiments, the liquid medium (L) is a mixture of water, propanol(s), preferably 1-propanol, and DMSO2.

Preferably the fluorinated polymer in the liquid composition (LC) is in its ionic form, i.e. it comprises —SO₃Z functional groups, wherein Z is as defined above, and in particular —SO₃H functional groups.

The liquid composition (LC) comprising the at least one fluorinated polymer and cerium oxide (CeO₂) coated silica (SiO₂) particles may optionally comprise additional ingredients.

An object of the present invention is thus a process for the preparation of a liquid composition (LC) comprising blending the cerium oxide (CeO₂) coated silica (SiO₂) particles and the at least one fluorinated polymer comprising —SO₂X functional groups in a liquid medium (L).

The composition (C) of the invention is particularly suitable for the preparation of proton exchange membranes and electrocatalytic layers for use in fuel cell applications. It is also particularly suitable for the preparation of proton exchange membranes and electrocatalytic layers for use in water electrolysis applications. Indeed, the presence of the cerium oxide (CeO₂) coated silica (SiO₂) particles of the invention has shown to improve the resistance of fluorinated polymers comprising —SO₂X functional groups towards radical degradation as shown by the longer lifetime of proton exchange membranes obtained therefrom at the conditions of use.

As previously mentioned, during processes A, A′ and B according to the invention, the cerium oxide crystallites are formed onto the silica particles and thus bonded to said silica particles. Therefore, the cerium oxide scavenger can be immobilized inside a membrane avoiding dissolution during operation in fuel cell or electrolysis cell. In other words, cerium oxide is more stable towards leaching during the operation of the fuel cell or of the hydrolysis cell. Therefore the fluorinated membranes are protected for longer periods of time from radical induced degradation because of higher presence of cerium oxide. Additionally, electrocatalyst poisoning and shortening of the expected membrane lifetime due to dissolved cerium oxide are avoided.

Evaluation of the leaching of cerium oxide can be performed e.g. by submitting a membrane comprising the cerium oxide (CeO₂) coated silica (SiO₂) particles of the invention to a treatment in sulfuric acid solution. The amount of cerium oxide dissolved in sulfuric acid during the treatment of the membrane can then be evaluated by ICP-OES. Generally, the leaching of cerium oxide from a membrane comprising the cerium oxide (CeO₂) coated silica (SiO₂) particles of the invention is reduced when compared to the leaching of cerium oxide from a membrane comprising other sources of cerium element.

A further object of the present invention is an article comprising at least one fluorinated polymer comprising —SO₂X functional groups and cerium oxide (CeO₂) coated silica (SiO₂) particles as defined above.

In a first embodiment the article is a proton exchange membrane for a fuel cell application, herein referred to also as a “membrane″.

Compositions (C) comprising the at least one fluorinated polymer, typically comprising —SO₂X′ functional groups, preferably —SO₂F functional groups, and the cerium oxide (CeO₂) coated silica (SiO₂) particles in solid form may advantageously be converted into membranes by conventional extrusion techniques.

The extruded films can subsequently be converted into ion conducting membranes by hydrolysis, i.e. conversion of the —SO₂X′ functional groups into the corresponding —SO₃H functional groups, as discussed above.

Membranes can be obtained from liquid compositions (LC) according to the invention comprising the at least one fluorinated polymer, typically comprising —SO₃Z functional groups, preferably —SO₃H functional groups, and the cerium oxide (CeO₂) coated silica (SiO₂) particles using techniques known in the art, such as impregnation, casting, coating, e.g. roller coating, gravure coating, reverse roll coating, dip coating, spray coating.

The membranes may optionally be reinforced, for instance by lamination of the extruded membrane to a suitable reinforcing support or by impregnation of the liquid composition (LC) onto a porous support. Suitable supports may be made from a wide variety of components. The porous supports may be made from hydrocarbon polymers such as woven or non-woven polyolefin membranes, e.g. polyethylene or polypropylene, or polyesters, e.g. poly(ethylene terephthalate). Porous supports of fluorinated polymers are generally preferred for use in fuel cell applications because of their high chemical inertia. Biaxially expanded PTFE porous supports (otherwise known as ePTFE membranes) are among preferred supports. These supports are notably commercially available under trade names GORE-TEX®, TETRATEX®.

In a second embodiment the article is an electrocatalytic layer.

Electrocatalytic layers may advantageously be prepared starting from a liquid composition (LC) according to the invention comprising catalyst particles in addition to the at least one fluorinated polymer, typically comprising —SO₃Z functional groups, preferably —SO₃H functional groups, and the cerium oxide (CeO₂) coated silica (SiO₂) particles. Said liquid compositions are generally referred to as “catalytic inks”. Typical catalyst particles comprise an active compound selected among metals like iron, manganese, cobalt, nickel, platinum, ruthenium, gold, palladium, rhodium, iridium; their electro conductive oxides and alloys. The active compound is generally supported on a suitable material, herein called “carrier”, which is preferably electrically conductive. The carrier is advantageously chosen from carbon powder, for instance carbon black.

The amount of catalyst particles (including the carrier, if any) in the catalytic ink is generally of at least 1 wt % based on the total weight of the catalytic ink. Preferably, it is of at least 3 wt % and more preferably of at least Swt %. The amount of catalyst particles (including the carrier, if any) in the catalytic ink is advantageously of at most 50 wt % based on the total weight of the catalytic ink, preferably of at most 40 wt % and more preferably of at most 30 wt %.

The electrocatalytic layers may for instance be prepared by screen printing or solution coating the catalyst ink on the surface of a proton exchange membrane. The proton exchange membrane may comprise cerium oxide (CeO₂) coated silica (SiO₂) particles, having the same or different composition as the cerium oxide (CeO₂) coated silica (SiO₂) particles present in the catalytic ink, or it may be free of the cerium oxide (CeO₂) coated silica (SiO₂) particles.

In a third embodiment the article is a membrane electrode assembly. The membrane electrode assembly comprises a membrane having first and second surface, a first electrocatalytic layer adhered to said first surface and a second electrocatalytic layer adhered to said second surface, wherein at least one of said membrane, said first or second electrocatalytic layers comprises at least one fluorinated polymer comprising —SO₂X functional groups and cerium oxide (CeO₂) coated silica (SiO₂) particles as defined above. When the cerium oxide (CeO₂) coated silica (SiO₂) particles are present in more than one component of the membrane electrode assembly it may be the same or different.

Finally an object of the present invention is a fuel cell or an electrolysis cell comprising the article as above defined.

All definitions and preferences defined previously within the context of cerium oxide (CeO₂) coated silica (SiO₂) particles or of the process for their preparation apply to the compositions comprising the cerium oxide (CeO₂) coated silica (SiO₂) particles and a fluorinated polymer composition as well as to any article containing said compositions.

The invention will be now described in more detail with reference to the following examples, whose purpose is merely illustrative and not intended to limit the scope of the invention.

### EXAMPLES

### Characterization

### Ce Content by ICP-OES

Inductively coupled plasma optical emission spectroscopy (ICP-OES) was performed on mineralized samples prepared by dissolving cerium oxide using a mixture of nitric and hydrochloric acids.

Optical emission spectroscopy was used to detect and quantify ionized elements using wavelengths at 418.660 and 446.021 nm for Ce and 180.672 and 181.975 for S.

### Specific Surface Area of the Particles by BET Method

Specific surface area of the particles was measured according to the Brunauer-Emet-Teller (BET) method described in “The journal of the American Chemical Society”, vol. 60, page 309, February 1938.

### Crystallite Size by XRD

The XRD diffractograms of the powders were acquired on a XRD goniometer Malvern Panalytical in the Bragg Brentano geometry, with a Cu X Ray tube (Cu K-alpha wavelength of 1.5406 A). Phase identification was performed using Highscore Plus analytical software provided by the fabricant. Ceria crystallite size was measured using the half width of the main peak of the XRD pattern using Highscore Plus analytical software.

### Particle Size Distribution by Laser Diffraction

The particle size distribution was obtained by laser diffraction from a dispersion of the composition in 1-propanol.

D₅₀ has the usual meaning used in the field of particle size distributions. Dn corresponds to the diameter of the particles for which n % of the particles have a diameter which is less than Dn on a volume basis. D₅₀ (median) is defined as the size value corresponding to the cumulative distribution at 50%. These parameters were determined from a distribution in volume of the diameters of a dispersion of the particles of the solid material in a solution, obtained with a laser diffractometer of Malvern Mastersizer 3000 type. Data were treated with optical model of Fraunhofer.

The laser diffractometer uses the technique of laser diffraction to measure the size of the particles by measuring the intensity of light diffracted as a laser beam passes through a dispersed particulate sample.

### Particles Milling

Product was milled as a powder using an IKA blade mill for 15 seconds before being deagglomerated in suspension in 1-propanol using ultraturrax agitator.

Resulting product was further wet milled in 1-propanol using a basket mill operating with ZrO₂ balls stabilized with Yttrium having a diameter of 0.1-0.2 mm.

### Example 1—Preparation of Cerium Oxide (CeO₂) Coated Silica (SiO₂) Particles Comprising 40 wt % of Ce Element with Regard to the Total Particles Weight ([Ce-40])

In a reactor 230 g SiO₂ (Tixosil® 43 supplied by Solvay), was dispersed in 3318 g of water so that obtaining a suspension comprising 6.5% by weight of silica and 1092.1 ml of a 8 wt % NH₃ water solution were added under stirring.

683.20 g of a Ce(NO₃)₃ solution 2.87 mol/L in water was then added into the reactor within 1 h under 400 rpm. The resulting slurry was further stirred during at least 30 min.

The obtained slurry was filtered and dewatered on a Buchner funnel to obtain a solid cake. pH of the filtrate was 9.2.

The obtained cake was then calcined at a temperature of 500° C. for 3 h in furnace.

The resulting powder had a specific surface area measured using BET method of 211 m²/g.

The size of the Ce02 crystallites as measured by XRD was 7.7 nm.

The Ce content as measured by ICP-OES was 37 wt %.

Wet milling in 1-propanol and further dilution allowed to prepare suspension of cerium oxide (CeO₂) coated silica (SiO₂) particles.

### Example 2—Preparation of Cerium Oxide (CeO₂) Coated Silica (SiO₂) Particles Comprising 50 wt % of Ce Element with Regard to the Total Particles Weight ([Ce-50])

In a reactor 175 g SiO₂ (Tixosil® 43 supplied by Solvay), was dispersed in 2517 g of water so that obtaining a suspension comprising 6.5% by weight of silica and pH value was set at 8.5 adding a 8 wt % NH₃ water solution.

853.90 g of a Ce(NO₃)₃ solution 2.87 mol/L in water was then added into the reactor within 1 h under 400 rpm stirring while pH value was maintained at 8.5 by adding a 8 wt % NH₃ water solution. The resulting slurry was further stirred during at least 30 min.

The obtained slurry was filtered and dewatered on a Buchner funnel to obtain a solid cake.

The obtained cake was then calcined at a temperature of 500° C. for 3 h in furnace.

The resulting powder had a specific surface area measured using BET method of 166 m²/g.

The size of the CeO₂ crystallites as measured by XRD was 5.4 nm.

The Ce content as measured by ICP-OES was 49 wt %.

Wet milling in 1-propanol and further dilution with 1-propanol allowed to prepare suspension of cerium oxide (CeO₂) coated silica (SiO₂) particles.

Particles size distribution was obtained by laser diffraction from a dispersion of the composition in 1-propanol to give D₅₀=0.18 μm and D₅₀=0.41 μm

### Example 3—Preparation of Cerium Oxide (CeO₂) Coated Silica (SiO₂) Particles Comprising 60 wt % of Ce Element with Regard to the Total Particles Weight ([Ce-60])

In a reactor 130.6 g SiO₂ (Tixosil® 43 supplied by Solvay), was dispersed in 1879 g of water so that obtaining a suspension comprising 6.5% by weight of silica and pH value was set at 8.5 adding a 8 wt % NH₃ water solution.

1152.2 g of a Ce(NO₃)₃ solution 2.87 mol/L in water was then added into the reactor within 1 h under 400 rpm stirring while pH value was maintained at 8.5 by adding a 8 wt % NH₃ water solution. The resulting slurry was further stirred during at least 30 min.

The obtained slurry was filtered and dewatered on a Buchner funnel to obtain a solid cake.

The obtained cake was then calcined at a temperature of 500° C. for 3 h in furnace.

The resulting powder had a specific surface area measured using BET method of 144 m²/g.

The size of the CeO₂ crystallites as measured by XRD was 6.6 nm.

The Ce content as measured by ICP-OES was 57 wt %.

Wet milling in 1-propanol and further dilution in 1-propanol allowed to prepare suspension of cerium oxide (CeO₂) coated silica (SiO₂) particles.

### Comparative Example 1—Procedure for the Preparation of Mixed Oxides [MO-Ce-40] Scavenger Particles Comprising 40 wt % of Ce Element with Regard to the Total Particles Weight According to Process Described in WO 2014/009334

In a closed vessel SiO₂, water soluble Ce(NO₃)₃·6H₂O and (NH₄)₂SO₃—H₂O were suspended in water.

The weight ratio SiO₂: Ce(NO₃)₃·6H₂O: (NH₄)₂SO₃—H₂O was 200:593:62.1. The slurry was stirred at 80° C. for 10 h providing a gel. The gel thus obtained was heat treated according to the following conditions:
from room temperature to 150° C. (1 h ramp, 2.5° C./min);
2 h at 150° C.;
from 150° C. to 300° C. (1 h ramp, 2.5° C./min);
2 h at 300° C.

The powder obtained at the end of the heat treatment was cooled down to room temperature and then washed with 0.5M H₂SO₄ solution at 70° C. until no change in the amount of metal M and sulphur was determined by ICP-OES analysis of the sample. The powder was dried under vacuum at 80° C. for 2 h and then ground in a planetary ball mill for 2 h at 200 rpm.

The characteristics of cerium oxide (Ce02) coated silica (SiO₂) particles [Ce-40], [Ce-50] and [Ce-60] as prepared in Examples 1 to 3 and of mixed oxides [MO-Ce-40] scavenger particles as prepared in Comparative Example 1 are reported in Table 1 below.

TABLE 1

| Examples and | | Experimental | SSA | Crystallites |
|---|---|---|---|---|
| comparative | Theoretical | Ce (wt %) by | (m²/g) | size (nm) by |
| examples | Ce (wt %) | ICP-OES | by BET | XRD |
| Ex. 1 [Ce-40] | 40 | 37 | 211 | 7.7 |
| Ex. 2 [Ce-50] | 50 | 49 | 166 | 5.4 |
| Ex. 3 [Ce-60] | 60 | 57 | 144 | 6.6 |
| Comp. Ex. 1 | 40 | 40 | 152 | 11.3 |
| [MO-Ce-40] | | | | |

### Example 4—Preparation of a Fluorinated Polymer (P1) Comprising —SO₃H Functional Groups

In a 22 L autoclave the following reagents were charged:
11.5 L of demineralised water;
980 g of the monomer with formula: CF₂═CF—O—CF₂CF₂—SO₂F
3100 g of a 5% weight solution of
CF₂ClO(CF₂CF(CF₃)O)ₙ(CF₂₀)ₘCF2000K in water (average molecular weight=521, ratio n/m=10).

The autoclave, stirred at 470 rpm, was heated at 60° C. A water based solution with 6 g/L of potassium persulfate was added in a quantity of 150 mL. The pressure was maintained at a value of 12 bar (abs) by feeding tetrafluoroethylene.

After adding 1200 g of tetrafluoroethylene in the reactor, 220 g of the monomer CF₂═CF—O—CF₂CF₂—SO₂F were added every 200 g of tetrafluoroethylene fed to the autoclave.

The reaction was stopped after 280 min by stopping the stirring, cooling the autoclave and reducing the internal pressure by venting the tetrafluoroethylene; a total of 4000 g of tetrafluoroethylene were fed.

The latex was then coagulated by freezing and thawing and the recovered polymer was washed with water and dried at 150° C. for 24 hours. The polymer was then treated with fluorine gas in a metallic vessel for 8 hours at 80° C., then purged several hours with nitrogen to remove any residual unstable end-groups.

The polymer thus obtained was immersed in a KOH solution (10% by weight) at 80° C. for 8 hours, followed by washing in demineralised water at room temperature. Immersion in a HNO₃ solution (20% by weight) at room temperature for 2 hours, followed by washing in demineralised water at room temperature converted all functional groups into —SO₃H functional groups.

The resulting fluorinated polymer in —SO₃H form (P1) was then dried in a vacuum oven at 80° C. The equivalent weight of the polymer (EW) was determined (by IR analysis on the precursor polymer) to be 790 g/eq.

### Example 5—Suspensions Comprising the Cerium Oxide (CeO₂) Coated Silica (SiO₂) Particles Prepared in Example 2 and Mixed Oxides Scavenger Particles as Prepared in Comparative Example 1 Dispersed in 1-Propanol

A suspension in 1-propanol comprising 15 wt %, with regard to the total weight of the suspension, of cerium oxide (CeO₂) coated silica (SiO₂) particles [Ce-50] prepared in Example 2 was sonicated for 2 h obtaining complete dispersion of the solid. Solid content in dispersion was determined using a thermobalance (160° C., 45 min).

Similarly, a suspension in 1-propanol comprising 15 wt %, with regard to the total weight of the suspension, of [Mo—Ce-40] mixed oxides scavenger of Comparative Example 1 was prepared.

### Example 6—Liquid Compositions Comprising P1 and the Suspension of (CeO₂) Coated Silica (SiO₂) Particles Prepared in Example 5 or the Suspension of Mixed Oxides Scavenger Particles as Prepared in Comparative Example 1

The suspension comprising the cerium oxide (CeO₂) coated silica (SiO₂) particles [Ce-50] obtained in Example 5 was added to a water dispersion of P1 (20 g) further comprising 1-propanol (7.5 g), DMSO2 (1.6 g) and H₂O (3 g). This mixture was stirred at room temperature to homogenize the dispersion.

The amount of the cerium oxide (CeO₂) coated silica (SiO₂) particles [Ce-50] and of P1 added in the preparation of the liquid compositions was calculated to obtain a final content of cerium in the composition of 0.7%±0.1% w/w based on fluorinated polymer P1.

A liquid composition was prepared in a similar way from the suspension of mixed oxides scavenger particles as prepared in Comparative Example 1.

### Example 7—Membrane Preparation—General Procedure

The mixture of Example 6 was casted on a glass support using the doctor-blade technique with a wet thickness of 500 μm and then dried in a ventilated oven at a temperature of 60° C. for 1 hour, from 60° C. to 90° C. in 1 hour, and then from 90° C. to 190° C. in 1 hour. The thickness of the resulting membrane was 50±5 μm.

The amount of Ce element measured by ICP-OES in the membrane containing [Ce-50] was 0.7%±0.1% w/wt % with regards to the total weight of the membrane (M2).

The amount of Ce element measured by ICP-OES in the membrane containing [MO-Ce-40] was 0.8%±0.1% w/wt % with regards to the total weight of the membrane (M3).

### Example 8—Fuel Cell Characterization of Membranes Prepared in Example 7

Membranes obtained as described in Example 7 were assembled in a custom-designed stack fixture with an active area of 50 cm² and tested on a Greenlight Innovation G100 test stand. The membranes were assembled with self-made catalyst-coated gas diffusion layers (~0.35 mg/cm² Pt).

The membranes were tested at the following operating conditions:
Anode side flow: 250 nccm pure H₂, 61° C. dew point, 1 bar (abs)
Cathode side flow: 250 nccm pure O₂, 61° C. dew point, 1 bar (abs)
Cell temperature: 90° C.

The voltage was monitored during the test. The end of the test was set at a voltage below 0.7 V, which is typically assumed to indicate the formation of pinholes in the membrane. The results are reported in Table 2.

TABLE 2

| | | Ce % w/w in the | Time to reach |
|---|---|---|---|
| | | membrane | voltage <0.7 V |
| Membrane | RSP type | (ICP-OES) | (hours) |
| (M1) | None | 0 | 41 |
| (M2) | [Ce-50] | 0.7 ± 0.1 | 660 |
| (M3) | [MO-Ce-40] | 0.8 ± 0.1 | 275 |

With respect to a membrane comprising fluorinated polymer (P1) alone (reference membrane (M1)), the membrane (M2) comprising the cerium oxide coated silica particles of the invention shows a significant increase in stability under fuel cell operating conditions. Indeed, the time to reach a voltage below 0.7 V is 660 hours in the case of the membrane (M2).

Moreover, the membrane (M2) comprising the cerium oxide coated silica particles of the invention shows a significant increase in stability under fuel cell operating conditions with respect to the membrane (M3) comprising the mixed oxides scavenger prepared according to the process described in WO 2014/009334 in Comparative Example 1. Indeed, the time to reach a voltage below 0.7 V is 660 hours in the case of the membrane (M2) and only 275 hours in the case of the membrane (M3).

Thus, the use of the cerium oxide (Ce02) coated silica (SiO₂) particles according to the invention is advantageous over the use of prior art radical scavenger particles obtained by a different process and is believed to be more stable towards leaching during the operation of the fuel cell or the electrolysis cell for longer periods of time.

### Example 9—Determination of Stability Towards Ce Leaching in Acidic Medium of Cerium Oxide (CeO₂) Coated Silica (SiO₂) Particles Comprising 50 wt % of Ce Element with Regard to the Total Particles Weight ([Ce-50])

The preparation protocol of Example 2 was followed with the difference that the calcination of the cake was performed at a temperature of 700° C.

The resulting powder had a specific surface area measured using BET method of 122 m²/g. The size of the Ce02 crystallites as measured by XRD was 7.3 nm.

2 g of the calcined product was dispersed in 100 mL of 1 M H₂SO₄. The suspension was heated at 80° C. for 24 hours (Step 1). After 24 hours the suspension was centrifuged (9600 rpm 15 min—Sigma 6 16KS—Refrigerated bench top centrifuge, rotor Sigma 12269). The resulting solid was dispersed once again in 100 mL of 1 M H₂SO₄ and heated at 80° C. for 24 hours (Step 1).

Both supernatants were analysed by ICP-OES to determine the amount of Ce leached. The results in Table 3 show a very low level of leaching under acidic conditions.

TABLE 3

| % Ce leached | % Ce leached | % Ce |
|---|---|---|
| in Step 1 | in Step 2 | leached - Total |
| 7.6 | 6.1 | 13.7 |

1. Cerium oxide (CeO₂) coated silica (SiO₂) particles, optionally comprising inorganic —SO₂OZ functional groups, wherein Z is selected from the group consisting of H, alkaline metals and NH₄, comprising from 10 wt % to 70 wt % of Ce with regard to a total weight of the particles, wherein the particles have a specific surface area measured by BET method ranging from 80 m²/g to 220 m²/g, and comprise[CeO₂ crystallites having a size measured by XRD ranging from 5.0 nm to 10.0 nm.

2. The particles according to claim 1 wherein the particles have a particle size distribution such that a D₅₀ on a volume basis is less than 0.20 μm, the D₅₀ being obtained by laser diffraction from a dispersion of the particles in 1-propanol.

3. The particles according to claim 1 wherein a D₉₀ on a volume basis is less than 0.50 μm, the D₉₀ being obtained by laser diffraction from a dispersion of the particles in 1-propanol.

4. A liquid composition (LC1) comprising the particles according to claim 1, dispersed in a liquid medium (L1).

5. A process (process A) for preparation of the cerium oxide (CeO₂) coated silica (SiO₂) particles of claim 1 comprising:
a) providing an aqueous suspension comprising SiO₂, setting a pH value of the aqueous suspension between 8 and 9 by adding an ammonia (NH₃) aqueous solution;
b) adding under stirring to the aqueous suspension a Ce(NO₃)₃ water solution—while maintaining the pH value between 8 and 9 by adding ammonia solution to obtain a slurry comprising cerium hydroxide precipitated onto SiO₂;
c) filtering the slurry to recover the cerium hydroxide precipitated onto SiO₂ as a solid;
d) conducting a calcination of the solid under oxidative atmosphere, at a temperature ranging from 250 to 800° C. for a duration ranging from 1 to 10 h obtaining the cerium oxide (CeO₂) coated silica (SiO₂) in a form of particles;
e) optionally milling the particles.

6. A process (process A′) for preparation of the cerium oxide (CeO₂) coated silica (SiO₂) particles of claim 1, comprising:
a′) providing an aqueous ammonia solution (E) with a pH value set between 7 and 11;
b′) adding under stirring to the aqueous solution (E) an aqueous suspension (S2) comprising SiO₂ suspended in a Ce(NO₃)₃ water solution, while maintaining the pH value between 7 and 11 by adding an ammonia aqueous solution (E′), to obtain a slurry comprising cerium hydroxide precipitated onto SiO₂;
c′) filtering of the slurry to recover the cerium hydroxide precipitated onto SiO₂ as a solid fem;
d′) conducting a calcination of the solid under oxidative atmosphere, at a temperature ranging from 250 to 800° C. for a duration ranging from 1 to 10 h obtaining the cerium oxide (CeO₂) coated silica (SiO₂) in a form of particles;
e′) optionally milling the particles.

7. A process (process B) for preparation of the cerium oxide (CeO₂) coated silica (SiO₂) particles claim 1 comprising:
a″) providing an aqueous suspension comprising SiO₂, ammonia (NH₃) and optionally at least one source of inorganic groups —SO₂X;
b″) adding under stirring to the suspension a Ce(NO₃)₃ water solution in such an amount that a molar ratio of NH₃ provided in step a″) and Ce ranges from 2 to 4 to obtain a slurry comprising cerium hydroxide precipitated onto SiO₂;
c″) filtering the slurry to recover the cerium hydroxide Ce(OH)₃ precipitated onto SiO₂ as a solid;
d″) conducting a calcination of the solid under oxidative atmosphere at a temperature ranging from 250 to 800° C. for a duration ranging from 1 to 10 h obtaining the cerium oxide (CeO₂) coated silica (SiO₂) in a form of particles;
e″) optionally milling the particles.

8. A composition (C) comprising at least one polymer comprising —SO₂X functional groups, wherein X is selected from X′ or from OZ and wherein X′ is selected from the group consisting of F, Cl, Br, I and Z is selected from the group consisting of H, alkaline metals, NH₄, and cerium oxide (CeO₂) coated silica (SiO₂) particles of claim 1.

9. The composition (C) according to claim 8 wherein the cerium oxide (CeO₂) coated silica (SiO₂) particles are present in an amount of at least 0.1 wt % and not exceeding 20.0 wt % with regard to the weight of the polymer.

10. The composition (C) according to claim 8 wherein the at least one polymer comprising —SO₂X functional groups is a fluorinated polymer.

11. A liquid composition (LC) comprising the composition (C) of claim 8 dispersed in a liquid medium (L).

12. The liquid composition (LC) of claim 11 wherein in the at least one polymer X=OZ and Z=H.

13. A process for preparation of the composition according to any claim 8 comprising blending the cerium oxide (CeO₂) coated silica (SiO₂) particles and the at least one polymer comprising —SO₂X functional groups in solid form or in a liquid medium (L).

14. An article comprising the composition of claim 8.

15. The article according to claim 14, wherein the article is a proton exchange membrane, an electrocatalytic layer or a membrane electrode assembly.

16. A process for preparation of the article of claim 14 comprising impregnation, casting or coating of a liquid composition (LC) comprising the composition (C) dispersed in a liquid medium (L).

17. A fuel cell or an electrolysis cell comprising the article of claim 14.
